(19) United States
(12) Patent Application Publication
(10) Pub. No.: US 2007/0300181 A1
(43) Pub. Date: Dec. 27, 2007

(54) METHOD, PROGRAM, AND DATA PROCESSING SYSTEM FOR MODIFYING SHAPE OF DISPLAY OBJECT

(76) Inventor: YOHICHI HATTORI, Yokohama-shi (JP)

Correspondence Address: IBM CORPORATION;INTELLECTUAL PROPERTY LAW, 11400 BURNET ROAD, AUSTIN, TX, 78758, US

(21) Appl. No.: 11/769,015

(22) Filed: Jun. 27, 2007

(30) Foreign Application Priority Data
Jun. 27, 2006 (JP) 2006-176471

(51) Int. Cl. G06F 3/048

(52) U.S. Cl. 715/788; 715/764; 715/781

(57) ABSTRACT

To provide a method, a program, and a data processing system for efficiently operating the shape of a display object that contains a content display area. A method for modifying a shape of a display object containing a content display area on a display device is provided. The method includes displaying on the display device the display object containing the content display area, prompting a user to input a figure to the content display area on the display device, a generating a figure having a shape that the content display area can take based on a shape of the figure input by the user, and modifying the shape of the display object based on a shape of the generated figure.

### CROSS-REFERENCE TO RELATED APPLICATIONS

This application claims the benefit of priority of Japanese Patent Application No. 2006-176471 filed on Jun. 27, 2006, and entitled “METHOD, PROGRAM, AND DATA PROCESSING SYSTEM FOR MODIFYING SHAPE OF DISPLAY OBJECT” hereby incorporated by reference herein for all purposes.

### BACKGROUND

1. Technical Field

Embodiments of the present invention generally relate to a graphical user interface, and more specifically relate to, in a data processing system connected to a display device, a method, program, and data processing system for operating display of a display object on the display device.

2. Description of Related Art

Multi-window operating systems, which display concurrently executed multiple programs as multiple windows, are widely used for business applications and personal applications. Typical multi-window operating systems include Windows® operating system of Microsoft Corporation, Mac OS® of Apple Computer Inc., and X Window System in UNIX®.

For a data processing system having a multi-window operating system, user productivity largely depends on efficiency of operation of a window object on a display device (hereinafter referred to simply as “window”). For example, a user in a multi-window operating system may wish to resize (enlarge or reduce) a window such that only a portion of a content displayed in the window is displayed in a content display area to view as many windows as possible. One conventional approach to satisfy this desire is to click and drag a side or a corner of a window, resize the window, and then operate a scroll bar such that a portion of the content that the user wishes to display is correctly displayed. However, this approach imposes on a user a slightly cumbersome operation of moving a cursor to a side or a corner of a window, clicking and dragging it, and then operating a scroll bar. In other words, a difficult operation may be required to change the size of a window to a size necessary for displaying only a desired specific portion of content in some cases, having adverse effects on user productivity. Consequently, an improved window-resizing method, program, and data processing system are needed.

### BRIEF SUMMARY

A method, program, and data processing system for operating display of a display object on the display device are provided herein. In accordance with one embodiment of the present invention, a method for modifying a shape of a display object containing a content display area on a display device is provided. The described method comprises displaying on the display device the display object containing the content display area, prompting a user to input a figure to the content display area on the display device, generating a figure having a shape that the content display area can take based on a shape of the figure input by the user, and modifying the shape of the display object based on a shape of the generated figure.

According to one embodiment, the input figure is a handwritten figure (e.g., a rectangle) input by the user via an input device and the display object is a window object. In an embodiment, generating the figure having the shape that the content display area can take comprises detecting that a closed curve is formed in the figure input by the user generating the figure having the shape that the content display area can take in response to detection of the formation of the closed curve.

In another embodiment of the present invention, generating the figure having the shape that the content display area can take comprises displaying a temporary figure generated based on the shape of the figure input by the user and prompting the user to perform a modification operation to modify a shape of the temporary figure, where modifying the shape of the temporary figure is performed in response to the modification operation performed by the user, and a further operation, confirming the modified temporary figure as a final shape of the generated figure is performed in response to input of a final confirmation action by the user. In one embodiment, modifying the shape of the display object based on a shape of the generated figure may comprise modifying the shape of the display object such that the display object contains the content display area having the shape of the generated figure.

While this brief summary has been described above as a method for modifying a shape of a display object, embodiments of the present invention may include a data processing system, a program, and a program product (e.g., recording medium that stores the program and a medium that transmits the program).

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways including implementation in hardware, software, or a combination thereof, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

It is believed that the above features, advantages and purposes of the invention will be better understood from the following description of exemplary embodiments taken in conjunction with the accompany drawings, in which:

FIG. 1 illustrates an example of an external view of a data processing system according to an embodiment of the present invention.

FIG. 2 illustrates an example of a hardware configuration in an information processing apparatus suited for implementing the data processing system according to an embodiment of the present invention.

FIG. 3 is a functional block diagram of the data processing system according to an embodiment of the present invention.

FIG. 4 is a flowchart representing an operation of the data processing system according to an embodiment of the present invention.

FIG. 5 shows a desktop screen in the data processing system having a multi-window operating system according to an embodiment of the present invention.

FIG. 6 shows a scene of a window operated in the data processing system according to an embodiment of the present invention.

FIG. 7 shows another scene of the window operated in the data processing system according to an embodiment of the present invention.

FIG. 8 shows another scene of the window operated in the data processing system according to an embodiment of the present invention.

FIG. 9 shows another scene of the window operated in the data processing system according to an embodiment of the present invention.

FIG. 10 shows another scene of the window operated in the data processing system according to an embodiment of the present invention.

FIG. 11 illustrates an example of an external view of a data processing system 100 according to an embodiment of the invention.

The use of the same or similar reference symbols within the accompanying drawings is intended to indicate similar or identical items.

### DETAILED DESCRIPTION OF ILLUSTRATIVE EMBODIMENTS

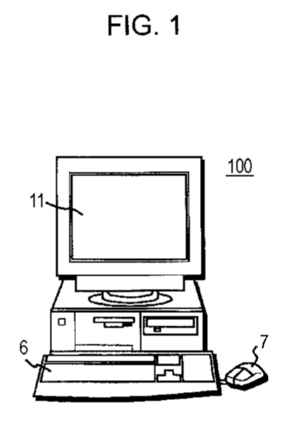

One or more illustrative embodiments of the present invention will now be described. With reference to the figures and in particular FIG. 1, an exemplary external view of a data processing system according to an embodiment of the present invention is depicted. The data processing system 100 of FIG. 1 includes a keyboard 6, a mouse 7, and a display device 11.

The display device 11 in the data processing system 100 according to an embodiment of the present invention visually provides information, such as one about a working status, for a user. The user operates a plurality of windows displayed on the display device 11 by the multi-window operating system via an input device, such as the keyboard 6 and the mouse 7, so that the user can use a desired application of one or more computer software applications. The user performs an operation of the displayed windows (e.g., window resizing) to efficiently use the application.

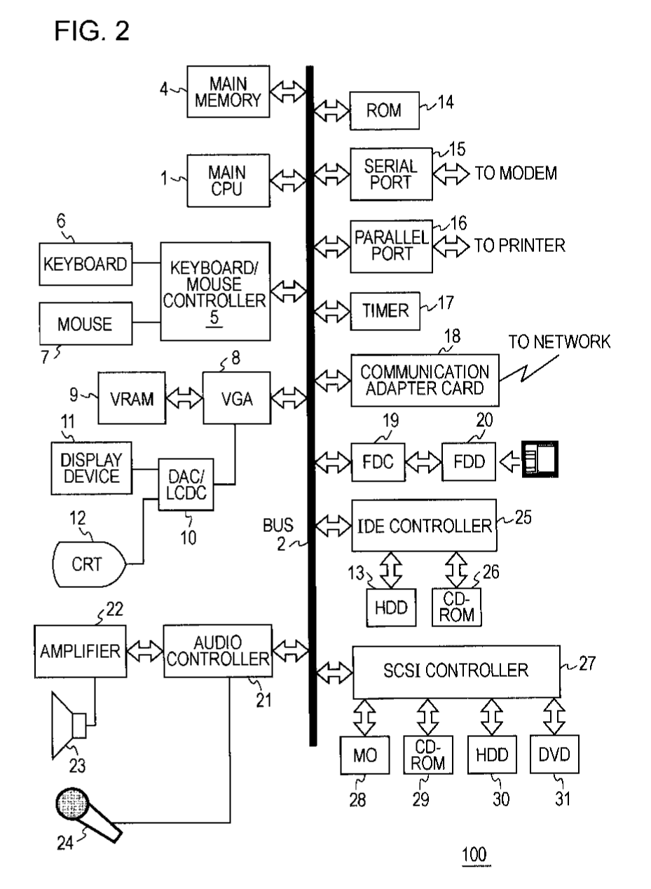

FIG. 2 illustrates an example of a hardware configuration in an information processing apparatus suited for implementing the data processing system 100 according to an embodiment of the present invention. The information processing apparatus includes a central processing unit (CPU) 1 and a main memory 4, both being connected to a bus 2. Hard disk drives 13 and 30 and removable storages (external storage systems whose recording media are replaceable), such as CD-ROM drives 26 and 29, a flexible disk drive 20, an MO drive 28, and a DVD drive 31, are connected to the bus 2 via an FD controller 19, an IDE controller 25, a SCSI controller 27, and the like.

A recording medium, such as an FD, an MO, a CD-ROM, and a DVD-ROM, is inserted into a removable storage. The recording medium, the hard disk drives 13 and 30, and a ROM 14 can store code of a computer program for providing instructions to a CPU and the like in cooperation with an operating system to carry out invention embodiments. The computer program is executed by being loaded into the main memory 4. The computer program can be compressed. The computer program can also be divided and recorded in a plurality of media.

The information processing apparatus receives input from an input device, such as the keyboard 6 and the mouse 7, via a keyboard/mouse controller 5. The information processing apparatus is connected to the display device 11 for providing visual data to a user via a DAC/LCDC 10.

The information processing apparatus is connected to a network via a network adapter 18 (e.g., Ethernet® card or a token-ring card) or the like and can communicate with other computers or the like. Although not shown in the figure, the information processing apparatus can be connected to a printer via a parallel port or to a modem via a serial port.

From the foregoing description, it will be readily understood that an information processing apparatus suited for implementing the data processing system 100 according to an embodiment of the present invention is implemented by a common information processing apparatus, such as a personal computer, a workstation, and a mainframe, or a combination thereof. The components described above are illustrative only, and not all the components are necessarily required for every embodiment of the invention.

It will, of course, be understood that those skilled in the art can readily reach various modifications, such as distribution of the functions of hardware components of the information processing apparatus used in an embodiment of the present invention into a combination of machines. These modifications are concepts contained within the scope of, and contemplated by the present invention.

The data processing system 100 adopts an operating system that supports a graphical user interface (GUI) multi-window environment, such as Windows® operating system from Microsoft Corporation, Mac OS® from Apple Computer Inc., and UNIX® system having X Window System (e.g., AIX® from International Business Machines Corporation).

From the foregoing, it can be understood that the data processing system 100 used in the described embodiment is not limited to a specific multi-window operating system environment.

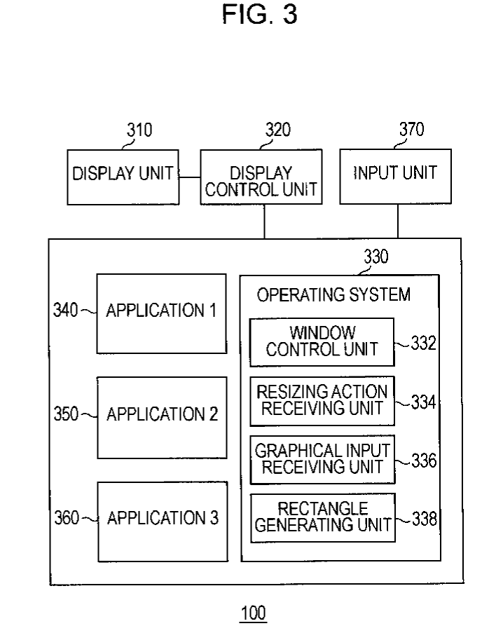

FIG. 3 is a functional block diagram of the data processing system 100 according to an embodiment of the present invention. The components shown in the functional block diagram of FIG. 3 can be implemented by, in an information processing apparatus that has a hardware configuration illustrated in FIG. 3, loading the operating system and computer program stored in the hard disk drives 13 into the main memory 4, then causing the CPU 1 to read the operating system and computer program, and causing the hardware resources and software to cooperate together.

The data processing system 100 includes a display unit 310, a display control unit 320, an operating system 330, applications 340, 350, and 360, and an input unit 370. The display unit 310 displays a desktop screen and the like in the multi-window operating system in response to an instruction from the display control unit 320. The display control unit 320 issues an instruction to display a screen to be displayed on the display unit 310 and controls an operation of the display unit 310. The input unit 370 is implemented by the keyboard 6, the mouse 7, and the like. The input unit 370 receives input (including a handwritten figure) from a user who operates the data processing system 100.

The operating system 330 provides a resource management function, which enables application software and the like to utilize resources of the data processing system 100. For example, the operating system 330 provides a hardware resource management function, a file handle function, a spool function, a job management function, a storage protection function, a virtual memory management function, and other functions (not shown). These functions are well known to those skilled in the art, so the detained description is omitted.

The operating system 330 includes a window control unit 332, a resizing action receiving unit 334, a graphical input receiving unit 336, and a rectangle generating unit 338. The window control unit 332 controls a running application of the applications 340, 350, and 360 as a window, provides a user with information by displaying the window on the display unit 310, and receives input from the user.

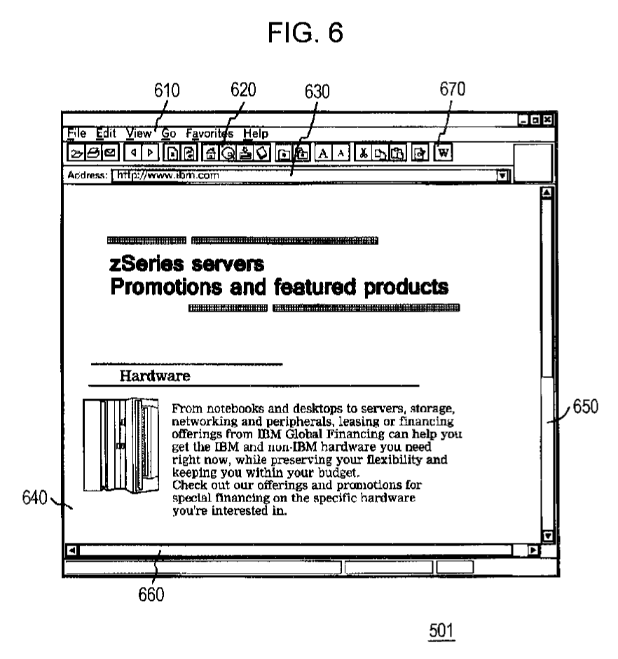

The resizing action receiving unit 334 has a function that shifts the system to a window resizing mode when a user who wishes to resize a window according to the described embodiment inputs a predetermined action. In this case, the predetermined action can be input of a predetermined shortcut key (e.g., SHIFT-R key combination) or can be selection of a button 670 (see FIG. 6), which is a selectable object in a window targeted for resizing.

The graphical input receiving unit 336 has a function of identifying user's graphical input, more specifically, input of a handwritten figure, performed when the data processing system 100 is in the window resizing mode and of sending necessary information to the rectangle generating unit 338. The rectangle generating unit 338 generates a rectangle required to resize a window size based on the information necessary to generate the rectangle received from the graphical input receiving unit 336.

Examples of the applications 340, 350, and 360 include a web browser, word processing software, spreadsheet software, presentation software, and other various applications. In one embodiment of the present invention, a web browser of these is used as an example, but it is to be noted that the present invention is not limited to these. In addition, three applications included in the data processing system 100 according to the described embodiment can be increased or reduced.

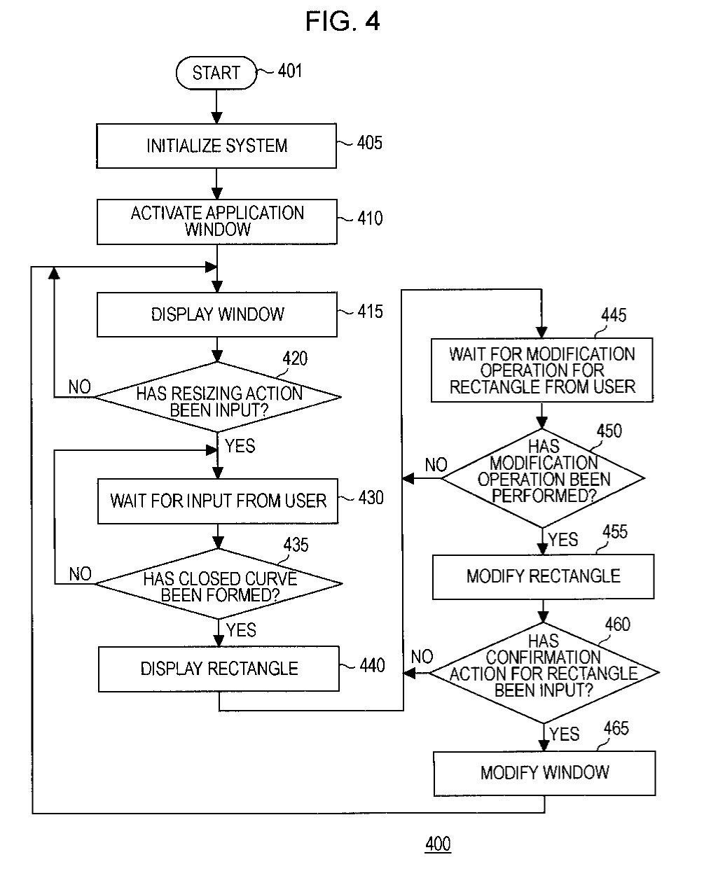

FIG. 4 is a flowchart 400 representing an operation of the data processing system 100 having the multi-window operating system according to an embodiment of the present invention. The processing starts (processing block 401) and thereafter the system is initialized (process block 405). In response to an application activation action from a user (e.g., a double click on an icon representing an application), an application program is activated (processing block 410). In the described embodiment, a web browser is used as an example of the application program.

The processing then proceeds and in response to the activation of the web browser, the window control unit 332 in the operating system 330 generates a window corresponding to the web browser on a desktop screen (processing block 415).

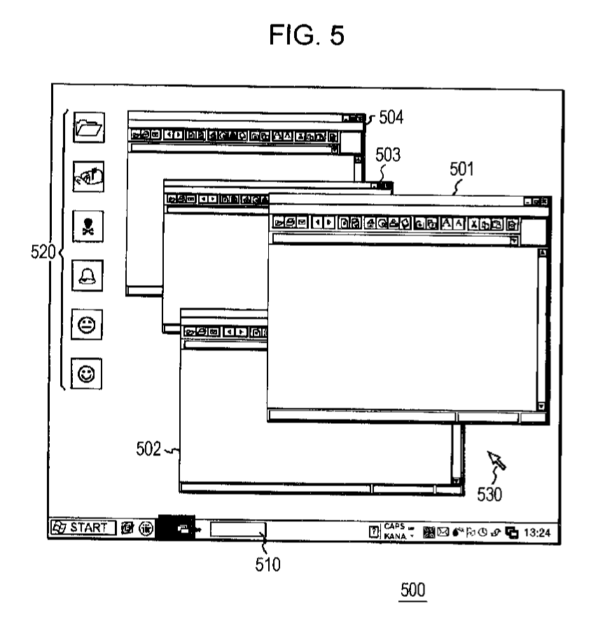

FIG. 5 shows an example of a desktop screen 500 displayed on the display unit 310 implemented by the display device 11 in the data processing system 100 having the multi-window operating system 330 after the operations described in connection with FIG. 4 compete. On the desktop screen, a plurality of windows 501 to 504, a task bar 510, icons 520, and a pointer 530 are displayed.

Each of the windows 501 to 504 represents a running application as a window. The task bar 510 is a bar for providing functions of the operating system 330. On the task bar 510, a start button, time, an icon of a resident program, and other items are displayed. The icons 520 represents a program, a directory (folder), and a file. In the described embodiment, when a user double-clicks an icon representing an application program with a pointer by using a mouse, the application is activated, and a window corresponding thereto is displayed. The details of such a multi-window operating system are well known to those skilled in the art, so the detailed description is omitted.

A window 501 on the desktop screen 500 is described with reference to FIG. 6. FIG. 6 shows an example of display of the window 501, which is an application window of the web browser. The window 501 includes a menu bar 610, menu icons 620, an address input field 630, a content display area 640, a vertical scroll bar 650, and a horizontal scroll bar 660. The functions of these items are well known to those skilled in the art, so the description is omitted.

In the described embodiment, it should be noted that the window 501 has a window resizing button 670. Positioning the pointer over the window resizing button 670 and clicking the window resizing button 670 shifts to a window resizing mode targeted for the window, and then the graphical input receiving unit 336 prompts a user to input a handwritten figure. The details thereof are described below with reference to the flowchart 400.

Referring back to FIG. 4, it is thereafter determined whether a window resizing action has been input by a user (processing block 420). Examples of the window resizing action include positioning the window resizing button 670 and clicking it, and the press of a predetermined shortcut key (e.g., SHIFT-R key combination). If input from the window resizing action is not detected, the processing returns (process block 415) via the NO arrow from process block 420 and continues displaying the window.

If the input from the window resizing action is detected (process block 420), the processing proceeds to wait for a graphical input from the user (process block 430). In this operation, the user can operate a mouse and input a handwritten line figure, for example. The user can input the handwritten line figure by using another input device, such as a tablet.

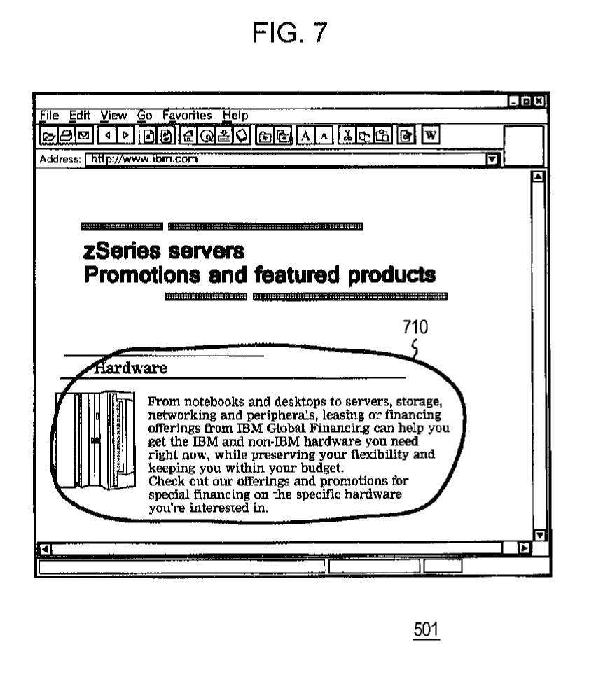

The processing next proceeds and it is determined whether a closed curve has been formed in the figure input by the user (process block 435). FIG. 7 shows an example of a FIG. 710 in which the closed curve has been formed. If it is determined that the closed curve has not been formed in the figure input by the user, the processing returns (process block 430) via the NO arrow from process block 435 and continues waiting for a graphical input from the user.

If, it is determined (process block 435) that the closed curve has been formed in the figure input by the user, the processing proceeds (process block 440) via the YES arrow from process block 435, and calculates a rectangle that contains the closed curve, and draws it.

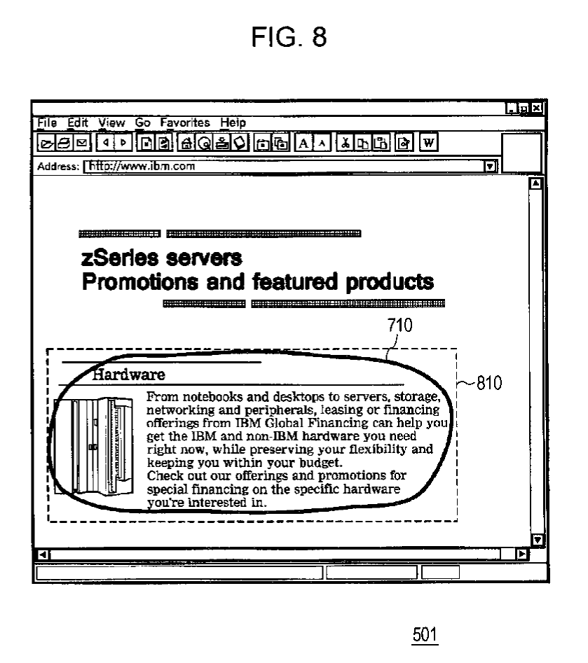

The rectangle that contains the closed curve is calculated in a way described below. The maximum and minimum x and y coordinates (represented by Xmax, Xmin, Ymax, and Ymin) are calculated, a rectangle that has as vertices (Xmin, Ymin), (Xmax, Ymin), (Xmin, Ymax), and (Xmax, Ymax) is calculated, and the rectangle is displayed. FIG. 8 shows a rectangle 810 displayed after being calculated based on the closed curve 710.

In the described embodiment, (process block 435), the figure input by the user is entirely contained in the content display area 640. However, the figure input by the user may be a figure that is partially superimposed on the content display area 640 or a figure that is not superimposed on the content display area 640. In this case, a rectangle may be calculated based on only a portion that is superimposed on the content display area 640, and the shape of a window may be resized in a way described below. Alternatively, a rectangle that extends outside the content display area 640 may be calculated based on the entire input figure, and the shape of a window may be resized in a way described below such that a portion of the content that was not displayed outside the content display area 640 is displayed.

The processing proceeds (process block 445) and prompts a user to perform a modification operation of modifying the shape of a displayed rectangle. If the calculated and displayed rectangle does not match with a necessary display area that the user intends, the user performs the modification operation for the rectangle by clicking and dragging a side or a vertex of the rectangle or other operation with a mouse. Then, the processing proceeds (process block 450) and determines whether the modification operation for the rectangle has been performed.

If, it is determined (process block 450) that the modification operation has not been performed, the processing returns (process block 445) via the NO arrow from process block 450 and until input of the modification operation for the rectangle is provided by the user.

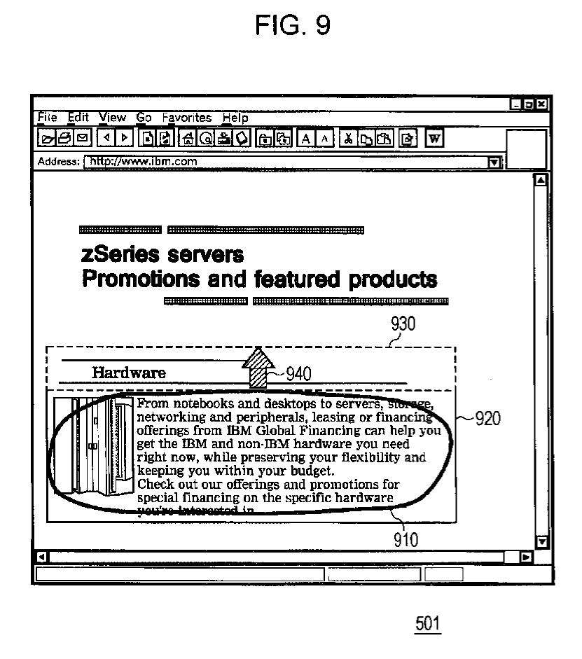

If, it is determined (process block 450) that the modification operation has been performed, the processing proceeds (process block 455) via the YES arrow from process block 450. The shape of the displayed rectangle is modified (process block 455) based on input of the modification operation for the rectangle, and the modified rectangle is displayed. FIG. 9 shows an example of a rectangle 930, which is generated by being modified by upward extension (940) of a temporary rectangle 920 generated based on a closed curve 910.

The processing further proceeds (process block 460), which determines whether a confirmation action or a cancellation action has been input. One example of the confirmation action is to click the inside of the rectangle. One example of the cancellation action is to click the outside of the rectangle. If, it is determined (process block 460) that the cancellation action has been input, the processing returns (process block 445) via the NO arrow from the process block 460 and continues until input of the modification operation is provided by the user.

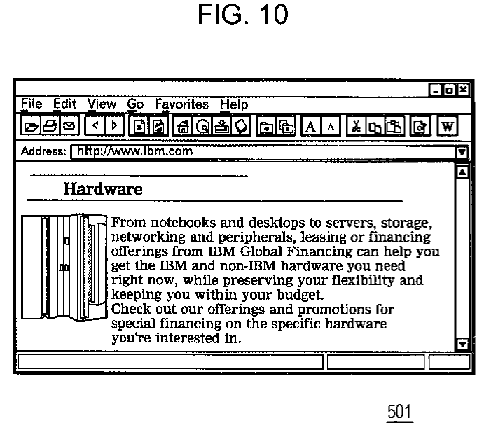

If, it is determined (process block 460) that the confirmation action has been input, the processing proceeds (process block 465) via the YES arrow from process block 460. Based on the confirmed rectangle, the shape of the window is actually modified (process block 465). More specifically, the shape of the window is modified such that the content display area in the window has the shape of the confirmed rectangle. FIG. 10 shows an example of the window that appears after the shape is modified according to an embodiment of the present invention. After the shape of the window is modified, the processing returns (process block 415), and the modified window is displayed.

At this time, if the handwritten figure and the rectangle generated on the basis thereof lie within the content display area, the window is reduced. In contrast, if part of the handwritten figure and the rectangle generated on the basis thereof lies outside the content display area, the window may be enlarged.

According to one embodiment of the present invention, a window can be resized such that only a portion of a displayed content is displayed on the content display area with a simpler operation. Therefore, it can be readily understood that the productivity of a user operating a multi-window operating system can be increased.

Embodiments of the present invention may be implemented in hardware, software, or a combination of both. A typical example of the combination of hardware and software is execution in a data processing system having a predetermined program. In this case, by being loaded into the data processing system and being executed, the program controls the data processing system and causes processing according to one or more embodiments of the present invention to be executed. The program consists of instructions that can be represented by any language, code, and notation. The instructions enable the system to perform a specific function directly or after either one of (1) conversion into another language, code, and notation and (2) reproduction to another medium or both.

Program product embodiments may comprise a medium storing a program, in addition to the program itself. Such a program product can be stored in any computer-readable recording medium, such as an FD, an MO, a CD-ROM, a DVD, an HDD, a ROM, an MRAM, and a RAM. To be stored in the recording medium, the program can be downloaded from other data processing systems connected thereto via a communication line and can be reproduced from another recording medium. The program can be compressed or divided into a plurality of portions and can be stored in a single or a plurality of recording media. Note that a program product implementing an embodiment of the invention can be provided in various forms.

Although embodiments of the present invention have been described on the assumption that the window resizing function would be implemented as one function of the operating system, the implementation of the function at the application level can be made. In addition, although the rectangle contains a closed curve included in a handwritten figure in the described embodiment, the rectangle can contain the entire handwritten figure.

In the described embodiment of the invention, after a rectangle is generated based on a handwritten figure, a modification operation of modifying the shape of the rectangle is received from a user, a final confirmation action is received from the user, and then the shape of the a window is changed. However, in response to formation of a closed curve, the shape of the window can be promptly changed without confirmation from the user. In addition, although, in the described embodiment, the shape of a window is changed without change of the position of a generated rectangle, the shape of the window can be changed after the rectangle is moved to the upper left of a content display area prior to changing of the shape of the window.

Although the generation of a rectangle from a handwritten figure has been described, the content display area can have a shape other than the rectangle. In this case, by appropriately generating a shape that the content display area can take from the handwritten figure, embodiments of the present invention may be applied to other types of display objects. For example, if the content display area is a display object whose content display area can take a circular shape, a circle that contains a closed curve in a handwritten figure can be generated, and, in accordance with this, the display object can be changed.

It is obvious to those skilled in the art that the above-described various modifications or improvements can be added. It is to be noted that implementations to which such modifications or improvements are added can be included in the technical scope of the invention.

What is claimed is:

1. A method for modifying a shape of a display object containing a content display area on a display device in a data processing system having the display device, the method comprising:
displaying on the display device the display object containing the content display area;
prompting a user to input a first figure to the content display area on the display device;
generating a second figure having a shape that the content display area can take based on a shape of the first figure input by the user; and
modifying the shape of the display object based on a shape of the second figure.

2. The method according to claim 1, wherein the first figure is a handwritten figure input by the user via an input device.

3. The method according to claim 2, wherein the second figure is a rectangle that contains a closed curve included in the handwritten figure.

4. The method according to claim 2, wherein the second figure is a similar figure of the content display area, the similar figure containing a closed curve included in the handwritten figure.

5. The method according to claim 2, wherein the second figure is a rectangle that contains the entire handwritten figure.

6. The method according to claim 1, wherein generating the second figure having the shape that the content display area can take includes detecting that a closed curve is formed in the first figure input by the user and generating the second figure having the shape that the content display area can take in response to a detection of the formed closed curve.

7. The method according to claim 6, wherein the second figure is generated based on a shape of the closed curve.

8. The method according to claim 1, wherein generating the second figure having the shape that the content display area can take includes:
displaying a temporary figure generated based on the shape of the first figure input by the user and prompting the user to perform a modification operation of modifying a shape of the temporary figure; and
modifying the shape of the temporary figure in response to a performance of the modification operation.

9. The method according to claim 8, wherein generating the second figure having the shape that the content display area can take further includes confirming the shape of the temporary figure as a final shape of the second figure in response to input of a final confirmation action by the user.

10. The method according to claim 1, wherein modifying the shape of the display object based on a shape of the second figure includes modifying the shape of the display object such that the display object contains the content display area having the shape of the second figure.

11. The method according to claim 1, wherein the shape of the display object is modified without changing a position of the second figure.

12. The method according to claim 1, wherein the second figure is moved to an upper left area of a current position of the content display area.

13. The method according to claim 1, wherein, when the second figure lies within the content display area, the display object is reduced in displayed size.

14. The method according to claim 1, wherein, when a portion of the second figure lies outside the content display area, the display object is enlarged in displayed size.

15. The method according to claim 1, wherein the display object is a window object in a multi-window operating system.

16. The method according to claim 15, wherein the display object is a window object that supports a web browser.

17. The method according to claim 1, wherein prompting the user to input the first figure is performed in response to input of a predetermined user action.

18. The method according to claim 17, wherein the predetermined user action is input of a predetermined shortcut key.

19. The method according to claim 17, wherein the predetermined user action is selection of a selectable object displayed in association with the display object.

20. A program product comprising:
a machine-readable medium having a plurality of instructions executable by a machine embodied therein, wherein said plurality of instructions when executed cause said machine to perform a method for modifying a shape of a display object containing a content display area on a display device in a data processing system having the display device, the method comprising:
displaying on the display device the display object containing the content display area;
prompting a user to input a first figure to the content display area on the display device;
generating a second figure having a shape that the content display area can take based on a shape of the first figure input by the user; and
modifying the shape of the display object based on a shape of the second figure.

21. A data processing system to modify a shape of a display object containing a content display area comprising:
a display device;
means for displaying on the display device the display object containing the content display area;
means for prompting a user to input a first figure to the content display area on the display device;
means for generating a second figure having a shape that the content display area can take based on a shape of the first figure input by the user; and
means for modifying the shape of the display object based on a shape of the second figure.

22. A data processing system to modify a shape of a display object containing a content display area on a display device, the data processing system comprising:
a display unit to display the display object on the display device, the display object containing a content display area;
a prompting unit to prompt a user to input a first figure to the content display area on the display device;
a generation unit to generate a second figure having a shape that the content display area can take based on a shape of the first figure input by the user; and
a modification unit to modify the shape of the display object based on a shape of the second figure.
